(19) United States
(12) Patent Application Publication
(10) Pub. No.: US 2004/0066413 A1
(43) Pub. Date: Apr. 8, 2004

(54) Navigation system for data structures

(76) Inventor: Stefan Ahlqvist, Djursholm (SE)

Correspondence Address: Rolf Fasth, Fasth Law Offices, 629 E Boca Raton Road, Phoenix, AZ, 85022, US

(21) Appl. No.: 10/466,875

(22) PCT Filed: Feb. 1, 2002
(86) PCT No.: PCT/US02/03140

(51) Int. Cl. G09G 5/00

(52) U.S. Cl. 345/781

(57) ABSTRACT

A data structure is mapped on a two-dimensional display by providing a first view having a first number of products displayed therein, and a second view having a second number of products displayed therein. The first number is greater than the second number. In the first view, a first segment of the first view is selected by placing a cursor in a first place in the segment and activating the cursor. The second view is displayed so that the second view is centered at the first place. The second view is an enlargement of the first segment of the first view. In the second view, the first product is selected by placing the cursor on the first product and activating the cursor to display the product view of the first product

### TECHNICAL FIELD

The present invention relates to a method and device for navigating in data structures.

### BACKGROUND AND SUMMARY OF THE INVENTION

It is relatively cumbersome to navigate in large hierarchical data structures by using a conventional browser. For example, today's browser technology often only allows the viewer to see the contents of one node at a time. The viewer may start by viewing a top node of a conventional hierarchy and the viewer may select sub-nodes of this node and work his/her way down in the hierarchy. One important drawback of such a navigation system is that the viewer never obtains a good overview because the viewer only sees portions of the entire data structure at a time. The viewer has little idea of the size of the data structure. Another drawback is that the navigation is slow and ineffective and the viewer may reach many dead ends before the viewer finds what the viewer is looking for.

There is a need for an efficient and reliable way of navigating in a hierarchical data structure that provides the viewer with a good overall view and is efficient. The navigation system of the present invention is a method in which a hierarchical, or a non-hierarchical, data structure may be mapped on a two-dimensional display by providing a first view having a first number of products displayed therein and a second view having a second number of products displayed therein. The first number is greater than the second number. In the first view, a first segment of the first view may be selected by placing a cursor in a first place in the segment and activating the cursor. The second view is displayed so that the second view is centered at the first place. The second view is an enlargement of the first segment of the first view. In the second view, a first product may be selected by placing the cursor on the first product and activating the cursor to display the product view or web page of the first product. It is also possible to pane in the various views by dragging the cursor or by using the arrow keys.

### BRIEF DESCRIPTION OF THE DRAWINGS

FIG. 1 is a schematic view of an overall view of a product range displayed according to the landscape device of the present invention;

FIG. 2 is a schematic view of an enlarged more detailed view of a portion of the overall view of FIG. 1;

FIG. 3 is a schematic view of a product page; and

FIG. 4 is a schematic flow diagram of the method for implementing the landscape device of the present invention.

### DETAILED DESCRIPTION

One purpose of the present invention is to provide a display and suitable links to all web pages of a web site, or part of a web site, so that all products may be displayed side-by-side on one page in a way that makes them distinguishable for the user. According to the method of the present invention, the user is provided with an overview of the web site with many products obtained from web pages displayed on one screen. A sample product site has been chosen to exemplify this concept.

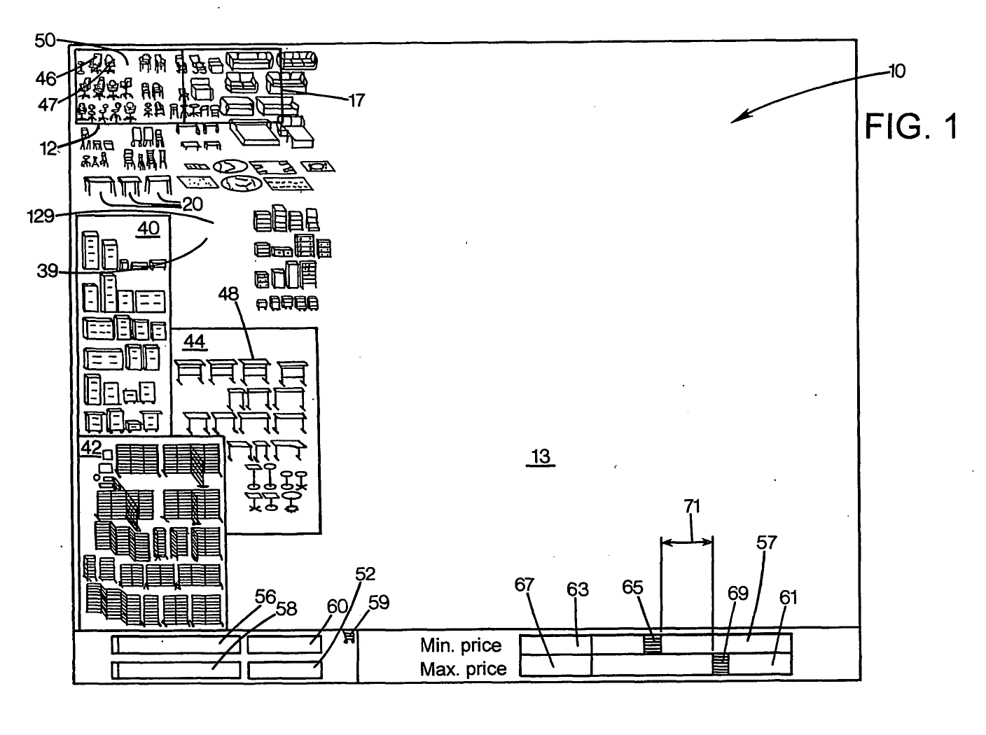

With reference to FIG. 1, the landscape 10 provides a good overview of all the products available on web pages of a site. There is no need to activate links to find sub-pages in a hierarchical linking system. The landscape may also be used in non-hierarchical systems. It may even be possible for a user to seamlessly move between web sites of different vendors so that the user may compare products from different vendors.

The navigation system of the present invention enables navigation in a view 13 of a two-dimensional flat landscape 10 so that the user may zoom and pane, as desired, to find and view the products displayed on the view 13. The products displayed on the view 13 may be sorted into groups. For example, the landscape 10 may sort or group similar products together so that, for example, shelf-related products form a shelf group 40, dividers form a divider group 42 and tables for a table group 44.

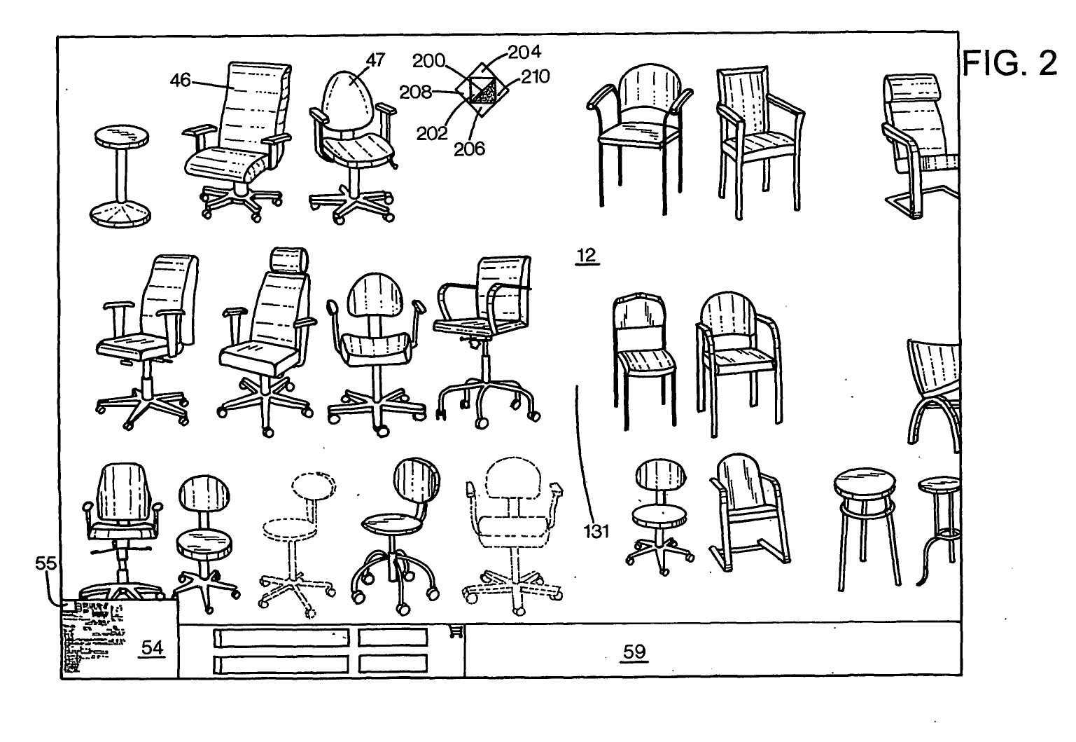

The display view 13 has a plurality of pressure sensitive icons that represent the products and may be activated by a conventional cursor that is operated by a computerized mouse device. The product icons are positioned at predetermined x-and y-coordinates in the display view 13. Each product icon is connected to a particular product or product group or web page so that when the icon is activated, the landscape will gradually enlarge the view until the view 12, as shown in FIG. 2, is displayed. If the user activates the cursor when the cursor is located in a background 131 between the products/web pages, the products closest to the activation spot may be displayed in the view 12, as shown in FIG. 2.

The landscape 10 distinguishes between primary and secondary groups. The products of a primary group are positioned so that they form a visually distinctive rectangle with spaces, such as space 39, or a border around the primary group. The product icons of such primary groups are positioned in a number of rows in which each icon may normally be bottom aligned so that it appears that the products are standing on a common floor or shelf.

Groups of primary groups may constitute a secondary group wherein the products of the primary groups are related to one another. For example, office lamps and office chairs may be two primary groups that are part of a larger secondary office furniture group. In this way, the primary groups may be sorted into secondary groups to make it easier for the user to find the products of the primary groups. Secondary groups do not form a distinctive rectangle but the products are positioned adjacent to each other with no icon from outside the group disposed in between. The positioning and separation of the primary groups reduce the visual noise or clutter of the landscape 10 that may be essential to such information-intensive displays.

One purpose of both primary and secondary groups is to reduce the logical disorder of the landscape 10, by showing related products or groups adjacent to each other. This improves the end user's ability to recognize patterns in the landscape 10. An added feature of the present invention is that it is not necessary to show all the details of each and every product shown in the view 13. When the products are grouped together with other similar products, such as the chair group, the viewer recognizes easier that one particular product is a chair because that product is next to other chairs.

A first attempt at grouping may be automatically performed by the landscape system 10 by copying the hierarchical structure of the product data base or web site. Each composite node in this hierarchy becomes a group. The system may make some of these groups primary in a way that the number of primary groups is roughly equal to the number of icons in a group. This minimizes the difference between the number of groups and the square root of the number of products in the landscape, as well as the difference between the number of icons in each group and the square root of the number of products in the landscape 10.

A developer may modify this first automatic sorting attempt by adding, moving and removing groups and icons/products in the view 13 as well as changing which groups are primary. It may be possible to position the various product items/web pages so that only products that match the selected product/web pages in some way are shown if the user moves in one direction. For example, if the user selects an executive chair in an upper right corner of a chair group, the user may simply move diagonally to the upper right to find a matching tables and book shelves. By continuing in the same direction the user may find more suitable products that match the selected products.

The view 13 of the landscape 10 may have a matching button 52 so that the user may, for example, highlight the tables and shelves that match the selected chair, as determined by predetermined links in the landscape 10. The user may mark a product in the landscape 10 and then activate the button 52 to view the products that go together with the selected product. For example, the landscape 10 may include link features so that a product item/web page in one group is linked to a product item/web page in another group. In this way, a table 48 in the group 44 may be recommended to go with the chair 46 of a chair group 50. In this way, the user may conveniently find the table 48 that matches the chair 46. Of course, the user may select another table if the user so desires.

The user may customize the display of the view 13 by modifying a price unit 56 and a width unit 58. For example, the unit 56 may be associated with a minimum price scale 57 and a maximum price scale 61. In this way, the view 13 only displays products that are in an interval 71 between a minimum price 63, as indicated determined by an indicator 65 of the scale 57, and a maximum price 67, as indicated by an indicator 69 of the scale 61. By making the interval 71 more narrow, the view 13 displays fewer products because any product that is less than the minimum price 63 or more than the maximum price 67 will not be shown in the view 13. Of course, any other suitable customizing criteria may be used and the above features are only used as examples to illustrate that the display may be customized. However, the products, that are outside the interval 71, may still be shown but less visibly.

The user may also activate an in-stock button 60 that indicates whether the selected products are in stock or not before a product is ordered. Rather than price it may be possible to customize on relative cost of the products so that the viewer specifies whether to see “cheap”, “medium”, “expensive” or “outrageous” products. Whether a product is cheap, medium, expensive or outrageous may be calculated from the price distribution within the primary group.

In view 13, the user may see several thousand different products/web-pages on a normal computer screen depending upon the set up of the landscape view. If the user zooms out from the icon view, an even more densely populated view may be seen. If only the hierarchical position, size and number of hits are indicated for the web pages, then several hundred thousand webpages/products may be shown on the screen. The landscape 10 is particularly suitable for selecting and comparing products that belong to a large product range.

When the viewer moves between views, for example with the zooming command, the visual transition between views may be done with animation. This way, the viewer does not loose track of the most interesting products/icons, the viewer was keeping his eye on. Animation may mean that the products grow gradually during perhaps a second so that the view starts in the first view and finishes in the second view.

The landscape 10 may not support continuous zooming, but only a few pre-compiled zoom levels such as the overall view 13, as shown in FIG. 1, and the more detailed and enlarged view 12, as shown in FIG. 2. Of course, the landscape 10 could be designed to support continuous zooming also, if desired. However, the pre-compiled zoom levels greatly improve performance that may be especially important for end users that access the data structure through a low-bandwidth communication vehicle such as the Internet. The pre-compiled zoom levels also make navigation easier because the user simply clicks where the user's interest is in the view 13 without having to be concerned about how much to zoom in.

The user may zoom by clicking on a product or a background 129 on the view 13 where the user's interest is. Preferably, the landscape system zooms in and centers at the location of the cursor where the user clicked. For example, if the user clicked while the cursor was in the upper right corner of the view 13, an enlarged view 12, as illustrated in FIG. 2, is shown. The view 12, as shown in FIG. 2, is also indicated in FIG. 1 with the reference numeral 12 so that the view shown in FIG. 2 is an enlargement of the segment view shown in FIG. 1. For example, the view 12 may be 36 times larger than the same area shown in the view 13. Of course, the view 12 may enlarge the view shown in the view 13 more or less than 36 times.

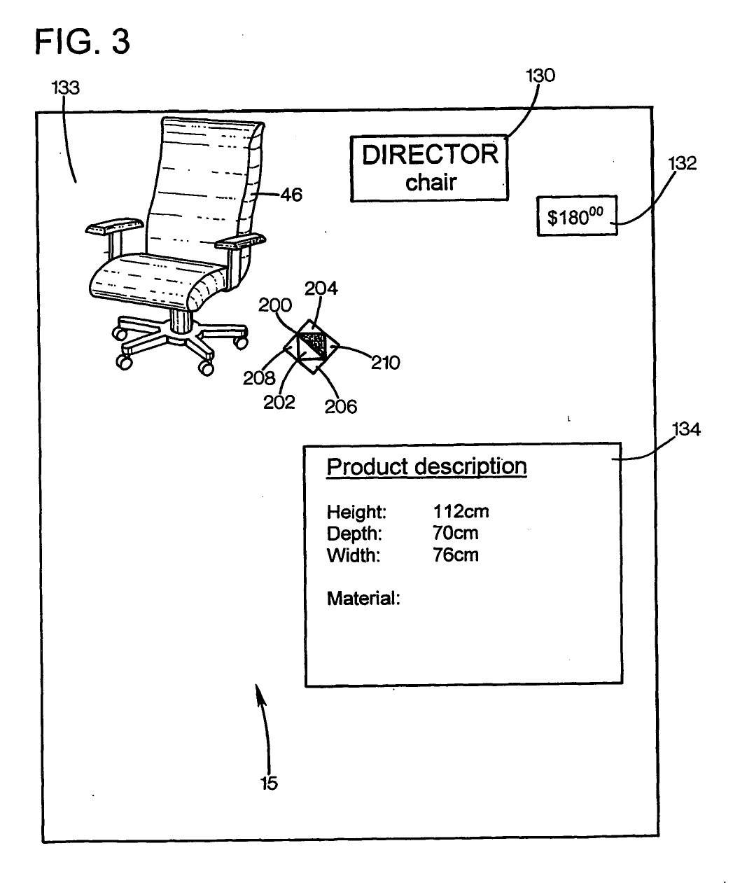

If the user, while in the display view 12, shown in FIG. 2, zooms once more by clicking on, for example, a chair 46 of the user's interest, the landscape system zooms in again to the product page of the chair 46, as shown in FIG. 3. The product page may be a conventional web page that describes only the selected product, as described in detail below. This direct compatibility between the display shown in FIG. 2 and the product page shown in FIG. 3 is important for backward compatibility because it, for example, reduces the cost of converting an existing web site to the landscape 10. Both the views in FIGS. 1-2 are automatically updated if the view of the chair 46 on the product page, as shown in FIG. 3, is updated or changed.

The user may also use a pane command which, for example, may mean that when the user is at the views shown in FIG. 2 or FIG. 3, the user may use a command on a mouse device by dragging the background 131 or a background 133 to the left. The pane command may be used on the view 13 also. The user may, at each level, pane the background in any desirable direction with the help of the arrow keys on the keyboard, the mouse or with the help of a landscape navigation control device 200.

The control device 200 has a pyramid-looking button 202 in the middle for a zoom out function. The device 200 has an up arrow 204 at the top for moving upwardly from the view 12 and a down arrow 206 at the bottom for moving downwardly from the view 12. The device 200 further has a left arrow 208 at the left for moving in the left direction and a right arrow 210 at the right for moving to the right from the view 12. The arrows 204, 206, 208, 210 may be set to move the view one full view, as represented by the size of the view 12. Of course, the arrows may be set to move the view less than one full view as represented by the view 12. For example, if the viewer is viewing view 12 and activates the right arrow 210, the screen will show a view 15 that is located to the right of the view 12. In other words, the user may pane in the right direction by pushing the right-arrow button 210 on the screen 12 or using a right-arrow key on the keyboard to move from the view 12 to see the view 15. The user may also move to the right by pushing the background 131 to the left. The view 15 may be a rectangular shaped portion of the view 10 and may have the same size as the view 12 and be positioned immediately to the right of the view 12, as shown in FIG. 1.

The view 12 has a position view 54 as shown in the left lower corner of the view 12 of FIG. 2. The view 54 is a miniature view of the view 13 and shows where on the entire view 13 the user is located so that the user may navigate more efficiently while the screen is displaying the view 12 or product page 15. The view 54 may be identical to the view 13 but much smaller, or it may only show the primary groups as filled gray rectangles with text indicating the titles of the largest primary groups and secondary groups of smaller primary groups. The view 54 also indicates to the user how much of the total web site is actually being displayed on the computer screen.

The view 12 is also indicated in the view 54 as a dark or colored rectangle view 55. The view 55 corresponds to the size of the view 12 relative to the larger view 13. A practical feature of the present invention is that the user may put the cursor on the rectangle view 55 and drag the rectangle to a desired position on the view 54. By dragging the view 55, the view 12 also moves to the same area so that user may navigate on the view 54 while the view 12 is being displayed on the screen of the computer monitor. In this way, the indicator view 55 on the display 54 may also be moved in the corresponding direction so that the user knows where on the corresponding view 13 the user is currently located.

As indicated above, when a suitable product has been located on the view 12, the user may click on the product icon, such as on the chair 46, to move to the product or web page 15 for the chair 46, as best shown in FIG. 3.

If the user is viewing the product page 15 for the chair 46, and uses a right command on the keyboard, the user may see the product page of a chair 47 that is located to the right of the chair 46 both in FIG. 1 and FIG. 2. In other words, the user may pane while at the product page level. Also, the user may maintain the cursor on the product to display a temporary mini-window to display more detailed product description and other data about the product. The user may also use the navigator 200 while at the product page 15, as described above.

For example, the user may zoom out from the product page 15 to the view 12 by using the button 202 of the navigator 200 on the screen or by pressing the escape key on the keyboard. If the user is on the product page/web page 15 and zooms out, the view 12 is displayed again and the view 12 is centered at the product, such as the chair 46, of the product page 15 that was previously viewed. If the user is in the view 12, as shown in FIG. 2, and zooms out, the system shows the view 13, as shown in FIG. 1.

The landscape 10 may have an updating feature so that all new products/web pages, that have been added to the landscape 10 since the user last visited the landscape 10, are marked in a different color or otherwise highlighted in a suitable way. The landscape 10 may also be designed so that only certain new products/web pages are highlighted depending upon which products/web pages the user were interested in last time the landscape 10 was visited by the user. For example, it may be possible to only highlight products/web pages at a certain price level or design style. In this way, products/web pages that are not likely to interest the user are not highlighted. Of course, the landscape 10 may be designed to highlight all new products/web sites also.

As indicated above, each product/web page icon, such as the product icon for the chair 46, has a view 12 associated therewith and the icons that are nearest the zoom-in-mouse-click may be shown in the format of the view 12. Preferably, when the user is in the view 12 and zooms in further, the user will be brought to the conventional product description page or other web page of the vendor's website.

The user may pane directly from one product page/web page to another product page/web page by activating the up, down, left or right arrows of the keyboard or navigator 200. For example, if the user is viewing a product description page and decides that the user would like to view another product description page that describes a different product, it is not necessary to zoom out and select another product. The user simply moves with the arrow commands or drags the background 133 of the product page to pane to view another product page, if so desired. In other words, the user may simply drag the background 133 of the product description page in a direction until a new product description page appears on the display.

It should be noted that the user may move in any direction, without having to zoom in or out, regardless of whether the user is at the view 13, the view 12 or the view 15. While in the view 12 and the view 15, it may also be possible for the user to pane so that the user is positioned between two product pages so that two halves are shown.

If the user is interested in a particular product/web page, the user may let the cursor remain on the icon for the product until a temporary mini-window appears with some basic information such as name, price, size, availability, etc. If the user decides to buy the product, the user may press a buy button so that the selected product will be added to a product cart 59 and the selected product is marked as having been bought. The user may also drag the selected products to be purchased directly to the product cart 59 that automatically adds up the total price amount for all the products in the product cart 59.

While in the view 15, the viewer may see product information segments such as a name of the product segment 130, a price segment 132 and a product description segment 134. The segment may have the actual physical dimensions of the product. This data may be used to make sure that the products displayed in the views 12 and 13 are proportional to the actual physical size although the displayed size of the products in the view 15 are the same. It is to be understood that the design of the view 15 is, preferably, up to the vendor of the product displayed. To speed up the downloading of pictures, the user may choose to do only incrementally or partially download the pictures so that the pictures are not shown in the highest display quality. The display quality may then improve if there is time before the user zooms or scrolls to another view. It is also possible that the server may automatically find out, without having to involve the user, the speed of the connection and adjust the quality of the picture based on this speed.

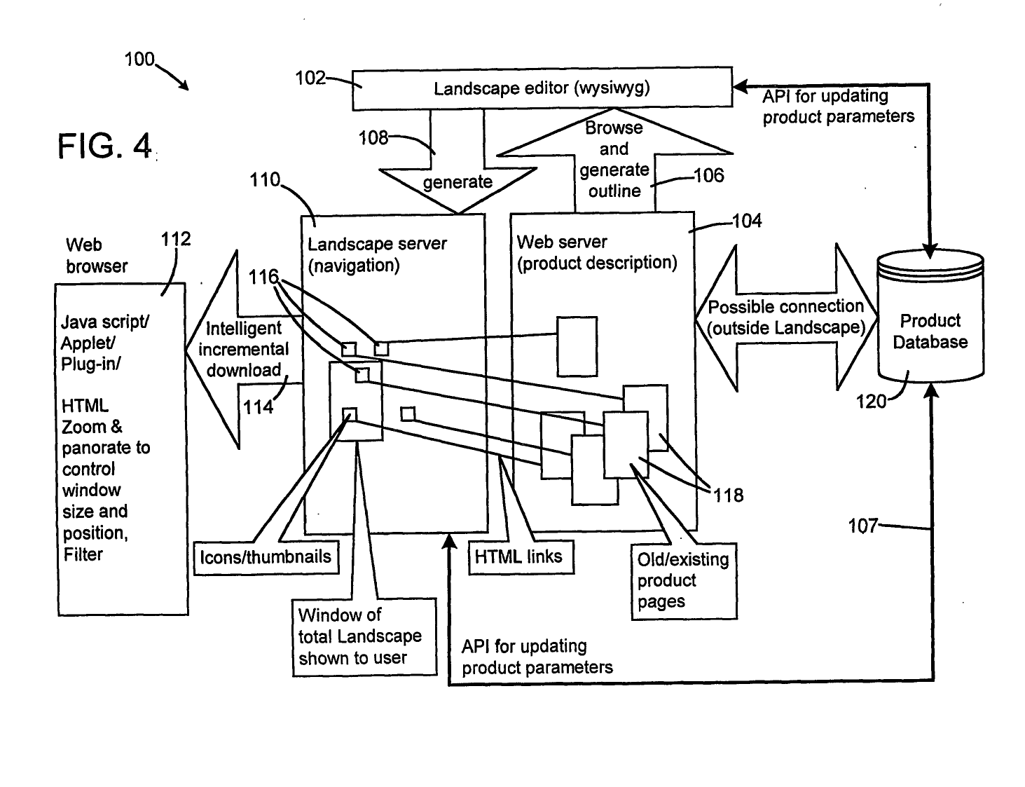

With reference to FIG. 4, the system 100 indicates a procedure for implementing the landscape device of the present invention to a conventional website. For example, the procedure may be used by owner's of web-sites who would like to implement the landscape device on their website. The downloading may either be free or require a licensing fee that may be based on the numbers of visitors.

The system has a landscape editor 102, such as a wysiwyg editor, that cooperate with a web server 104 for generating an outline of a landscape view, as shown by an arrow 106, for finding all the product descriptions that are located on the web server 104 so that a first outline may be generated. It may also be used to generate all basic icons and product groups on the display. More often, however, the landscape editor 102 will generate this outline from the product database 120 by a database signal 107. The icons may be generated into different sizes depending on the size of the actual objects the icons represent. The size of the product displayed may be to scale of the actual size of the product. The actual size of the product may be available from a database. This promotes end user comparison of different products as well as making it easier for the end user to find a particular product.

However, the quality of all the first outlines of the products may not always be sufficient. The editor 102 may then be used by developers and programmers to refine the draft by, for example, moving product items to a better place on the display and setting up different product group configurations. The editor 102 may then generate a landscape view, as shown by an arrow 108, to a landscape server 110 so that a user who has access to a web browser 112 may access the server 110 by downloading from the server 110, as indicated by an arrow 114.

In practice the server 110 may be part of the website 104 so that the user may first go to the website and then activate the server 110 from the website 104 to display the products/web pages in landscape format.

As indicated above, the server 110 has a plurality of icons 116 that are linked to product description pages/other web pages 118 of the web server 104. By activating an icon 116, the user may access the corresponding product description or web page 118 on the conventional web server of the vendor. The product description 118 is often pre-existing and prepared by the vendor for its web page.

The system 100 has a database 120 that may be linked to the web server 104. The server 110 may be directly connected to the database 120 so that when certain information is updated in the database, the server 110 is also updated. For example, when the price is changed in the database 120, the price on the server 110 is also updated automatically. The site owner may select the frequency of the updating procedure.

While the present invention has been described in accordance with preferred compositions and embodiments, it is to be understood that certain substitutions and alterations may be made thereto without departing from the spirit and scope of the following claims.

I claim:

1. A method of mapping a data structure on a two-dimensional display, comprising:
providing a first view having a first number of products displayed therein, a second view having a second number of products displayed therein, the first number being greater than the second number, a first product view displaying a first product, a second product view displaying a second product, the first product being displayed next to the second product in the first view and in the second view, the first number of products of the first view being sorted into predefined product groups;
in the first view, selecting a first segment of the first view by placing a cursor in a first place in the first segment and activating the cursor;
displaying the second view so that the second view is centered at the first place, the second view being an enlargement of the first segment of the first view; and
in the second view, selecting the first product by placing the cursor on the first product and activating the cursor to display the product view of the first product.

2. The method according to claim 1 wherein the method further comprises paning from the first product to the second product by activating an arrow key.

3. The method according to claim 1 wherein the method further comprises paning while in the second view by dragging a background of the second view.

4. The method according to claim 1 wherein the method further comprises paning while in the second view by activating a navigation control having a zoom out button and arrow keys.

5. The method according to claim 1 wherein the method further comprises while in the product view by activating a navigation control having a zoom out button and arrow keys.

6. The method according to claim 5 wherein the method further comprises activating the zoom out button while in the product view to display the second view and activating the zoom out button while in the second view to display the first view.

7. The method according to claim 6 wherein the method further comprises displaying the first product in a first position in the first view and in a second position in the second view, the first position being relatively the same position as the second position.

8. The method according to claim 1 wherein the method further comprises paning, while in the second view, by dragging a marker of a miniature view displayed in the second view.

9. The method according to claim 1 wherein the method further comprises customizing the number of products displayed on the first view by only displaying the products that are within a certain price range.

10. The method according to claim 1 wherein the method further comprises making at size of the products displayed in the first view proportional to an actual size of the products based on dimensions in a product database.
